(19) United States
(12) Patent Application Publication
(10) Pub. No.: US 2014/0181134 A1
(43) Pub. Date: Jun. 26, 2014

(54) PUSH-DOWN OF AUTHORITY CHECK WITHIN QUERY ENGINE

(71) Applicants: Marcel Hermanns, Walldorf (DE); Hans-Christian Humprecht, Heidelberg (DE); Cristina Buchholz, Reilingen (DE); Peter Drews-Walkling, Ahrensburg (DE); Roland Lucius, Darmstadt (DE)

(72) Inventors: Marcel Hermanns, Walldorf (DE); Hans-Christian Humprecht, Heidelberg (DE); Cristina Buchholz, Reilingen (DE); Peter Drews-Walkling, Ahrensburg (DE); Roland Lucius, Darmstadt (DE)

(21) Appl. No.: 13/724,706

(22) Filed: Dec. 21, 2012

(51) Int. Cl. G06F 17/30

(52) U.S. Cl. CPC G06F 17/30389
USPC 707/759

(57) ABSTRACT

A query engine for integrating authorization conditions within a database query statement. The query engine may include an authorization handler configured to receive authorization parameters related to one or more authorization objects for data relevant to a query for performing an authority check, and obtain at least one user authorization profile for a current user based on the authorization parameters. The at least one user authorization profile may include an activity value and one or more authorization conditions associated with the activity value. The query engine may further include a query generator configured to receive query parameters related to the query and integrate the query parameters with the one or more authorization conditions to obtain a database query statement, and a database selector configured to obtain authorized data from an in-memory database based on the database query statement.

### BACKGROUND

Conventionally, applications are responsible for reading data from a database, and providing an internal table to a user interface for display. However, application developers may want to restrict certain types of actions (e.g., read, write, change, etc.) on different types of data stored in the database. As such, an application developer may create one or more user profiles for a particular user which define the conditions for accessing certain types of data. In one example, the user may want to view, scroll, or sort data from a database. Before the data is displayed, the application may perform an authority check on the requested data in order to determine whether this data should be restricted. In conventional systems, the application reads all relevant data from the database relevant to the query execution, and then performs the authority check on the internal table containing the data in a loop over the retrieved data, one record at a time. For example, the application loads all relevant data in the internal table, and then applies the user profile to each row of loaded data in order to decide whether the row can be shown to the current user or not. However, this type of authority check may be considered relatively slow and inefficient because a relatively large amount of data is retrieved from the database, and the user may be authorized to view only a portion of the retrieved data (or none of it).

### SUMMARY

The embodiments provide a query engine for integrating authorization conditions within a database query statement. The query engine may include at least one processor, a non-transitory computer-readable storage medium including instructions executable by the at least one processor. The instructions may be configured to implement an authorization handler configured to receive authorization parameters related to one or more authorization objects for data relevant to a query for performing an authority check, and configured to obtain at least one user authorization profile for a current user based on the authorization parameters. The at least one user authorization profile may include an activity value and one or more authorization conditions associated with the activity value. The query engine may also include a query generator configured to receive query parameters related to the query and integrate the query parameters with the one or more authorization conditions to obtain a database query statement, and a database selector configured to obtain authorized data from an in-memory database based on the database query statement, the authorized data including a subset of data that is authorized for display.

The authorization handler configured to receive authorization parameters related to one or more authorization objects for data relevant to a query for performing an authority check may include receiving the authorization parameters from an application via an application programming interface (API).

The authorization parameters may include an identifier identifying an authorization object, a list of one or more activities each having at least one authorization object field and associated value, and mapping information mapping the at least one authorization object field to one or more data fields of the in-memory database.

The authorization handler configured to obtain at least one user authorization profile for a current user based on the authorization parameters may include obtaining the at least one user authorization profile having the activity value that matches the associated value of the authorization object field.

The query generator configured to receive query parameters related to the query and integrate the query parameters with the one or more authorization conditions to obtain a database query statement may include integrating the query parameters with the one or more data fields such that the database query statement corresponds to a format of the in-memory database. The one or more data fields may relate to a column or row in the in-memory database, and the one or more authorization conditions may relate a range within the column or row.

The query generator configured to receive query parameters related to the query and integrate the query parameters with the one or more authorization conditions to obtain a database query statement may include transforming a format of the one or more authorization conditions into one or more conditions according to a set of conversion rules. The one or more authorization conditions may include a range of values associated with the activity value, and the query generator may be configured to specify the range of values in the database query statement, and the database selector may be configured to obtain data corresponding to the range of values from the in-memory database as the authorized data.

The query parameters may relate to at least one of paging, sorting, filtering, and aggregation and grouping.

The embodiments may provide a computer program product tangibly embodied on a non-transitory computer-readable storage medium and including executable code that, when executed, is configured to cause a query engine to integrate authorization conditions within a database query statement. The executable code may include instructions to receive authorization parameters related to one or more authorization objects for data relevant to a query for performing an authority check, obtain at least one user authorization profile for a current user based on the authorization parameters, where the at least one user authorization profile may include an activity value and one or more authorization conditions associated with the activity value. The instructions may include instructions to receive query parameters related to the query and integrate the query parameters with the one or more authorization conditions to obtain a database query statement, and obtain authorized data from an in-memory database based on the database query statement, where the authorized data may include a subset of data that is authorized for display.

The instructions to receive authorization parameters related to one or more authorization objects for data relevant to a query for performing an authority check may include receiving the authorization parameters from an application via an application programming interface (API).

The authorization parameters may include an identifier identifying an authorization object, a list of one or more activities each having at least one authorization object field and associated value, and mapping information mapping the at least one authorization object field to one or more data fields of the in-memory database.

The instructions to obtain at least one user authorization profile for a current user based on the authorization parameters may include obtaining the at least one user authorization profile having the activity value that matches the associated value of the authorization object field. The instructions to receive query parameters related to the query and integrate the query parameters with the one or more authorization conditions to obtain a database query statement may include integrating the query parameters with the one or more data fields such that the database query statement corresponds to a format of the in-memory database. The one or more data fields may relate to a column or row in the in-memory database, and the one or more authorization conditions may relate a range within the column or row.

The instructions to receive query parameters related to the query and integrate the query parameters with the one or more authorization conditions to obtain a database query statement may include transforming a format of the one or more authorization conditions into one or more conditions according to a set of conversion rules. The one or more authorization conditions may include a range of values associated with the activity value, and the instructions may include specifying the range of values in the database query statement, and obtaining data corresponding to the range of values from the in-memory database as the authorized data.

The embodiments may provide a method for integrating authorization conditions within a database query statement. The method may include receiving, by at least one processor, authorization parameters related to one or more authorization objects for data relevant to a query for performing an authority check, obtaining, by at least one processor, at least one user authorization profile for a current user based on the authorization parameters. The at least one user authorization profile may include an activity value and one or more authorization conditions associated with the activity value. The method may further include receiving, by at least one processor, query parameters related to the query and integrating, by at least one processor, the query parameters with the one or more authorization conditions to obtain a database query statement, and obtaining, by at least one processor, authorized data from an in-memory database based on the database query statement, the authorized data including a subset of data that is authorized for display.

The authorization parameters may include an identifier identifying an authorization object, a list of one or more activities each having at least one authorization object field and associated value, and mapping information mapping the at least one authorization object field to one or more data fields of the in-memory database.

The obtaining at least one user authorization profile for a current user based on the authorization parameters may include obtaining the at least one user authorization profile having the activity value that matches the associated value of the authorization object field.

### BRIEF DESCRIPTION OF THE DRAWINGS

FIG. 1 illustrates a system for performing an authority check within a query engine according to an embodiment;

FIG. 2 illustrates an example of a screenshot of an ALV-based application depicting a sort and a page (scroll) according to an embodiment;

FIG. 3 illustrates an example of a screenshot of an ALV-based application depicting a filter according to an embodiment;

FIG. 4 illustrates an example of a screenshot of an ALV-based application depicting aggregation and grouping according to an embodiment;

FIG. 5 illustrates a method for obtaining authorization parameters to be provided to a query engine for performing the authority check according to an embodiment;

FIG. 6 illustrates an example of a first user authorization profile and a second user authorization profile related to a current user according to an embodiment;

FIG. 7 illustrates a database query statement according to an embodiment;

FIG. 8 illustrates a data flow for the authority check within the system of FIG. 1 and a conventional system according to an embodiment; and

FIG. 9 is a flowchart illustrating example operations of the performance of the authority check within the query engine according to an embodiment.

### DETAILED DESCRIPTION

The embodiments provide a mechanism that pushes down the authority check to a query engine (e.g., SADL Query Engine) at an application server (e.g., ABQI ABAP Query Interface), where the query engine enforces authorization restrictions during runtime before retrieving data from an in-memory database. For example, before data retrieval is executed, the query engine may enhance a database query statement by integrating authorization conditions as specified by a user's authorization profile within the query parameters, and then retrieve authorized data from the in-memory database based on the enhanced database query statement. In other words, instead of an application first loading all the data relevant to a particular query execution and then performing an authority check on a row-by-row basis to decide which row is authorized, the query engine may alter the database query statement (e.g., an SQL statement) to account for authorization restrictions in order to directly obtain data that is authorized from the in-memory database. As such, the authority check may be considered integrated within the query execution, which may decrease transaction speed and improve the overall performance of the authority check. As such, only the displayed data is retrieved from the in-memory database in order to minimize the response time and memory consumption in the ABAP. Also, with the enhanced database query statement, paging (or scrolling) may be enabled since the instance-based restrictions are also performed on the in-memory database.

In further detail, an application may provide authentication parameters for the authority check to an application programming interface (API) (e.g., an Application List Viewer (ALV) API), and thereby to an underlying query engine. Before the data retrieval is executed, the query engine may evaluate user authorization profiles of the current user operating the application, map authorization object fields to the table/view column/row of the in-memory database, and add authorization restrictions to the database query statement. Then, the query engine may execute the database query statement enhanced with the authorization restrictions to obtain authorized data from the in-memory database. Next, the query engine may provide the authorized data for display on a user interface via the API. These and other features are further explained below with reference to the figures.

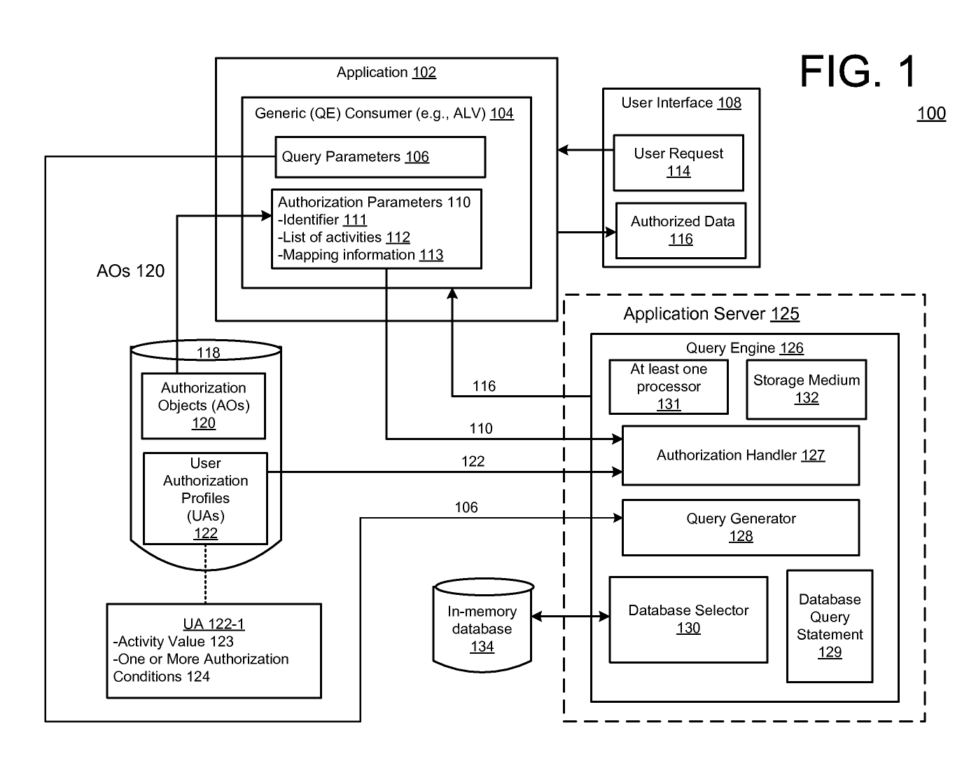

FIG. 1 illustrates a system 100 for performing an authority check within a query engine 126 according to an embodiment. For example, the system 100 may include a generic query engine (QE) consumer 104 executing on an application 102, a user interface 108 associated with the application 102 that receives one or more user requests 114 and, in response, displays authorized data 116, a database 118 storing authorization objects 120 and user authorization profiles 122, an application server 125 having a query engine 126 for enhancing query parameters 106 associated with the user request 114 with authorization conditions 124 to generate a database query statement 129, and an in-memory database 134 for storing data. However, the system 100 may include other components that are well known to one of ordinary skill in the art.

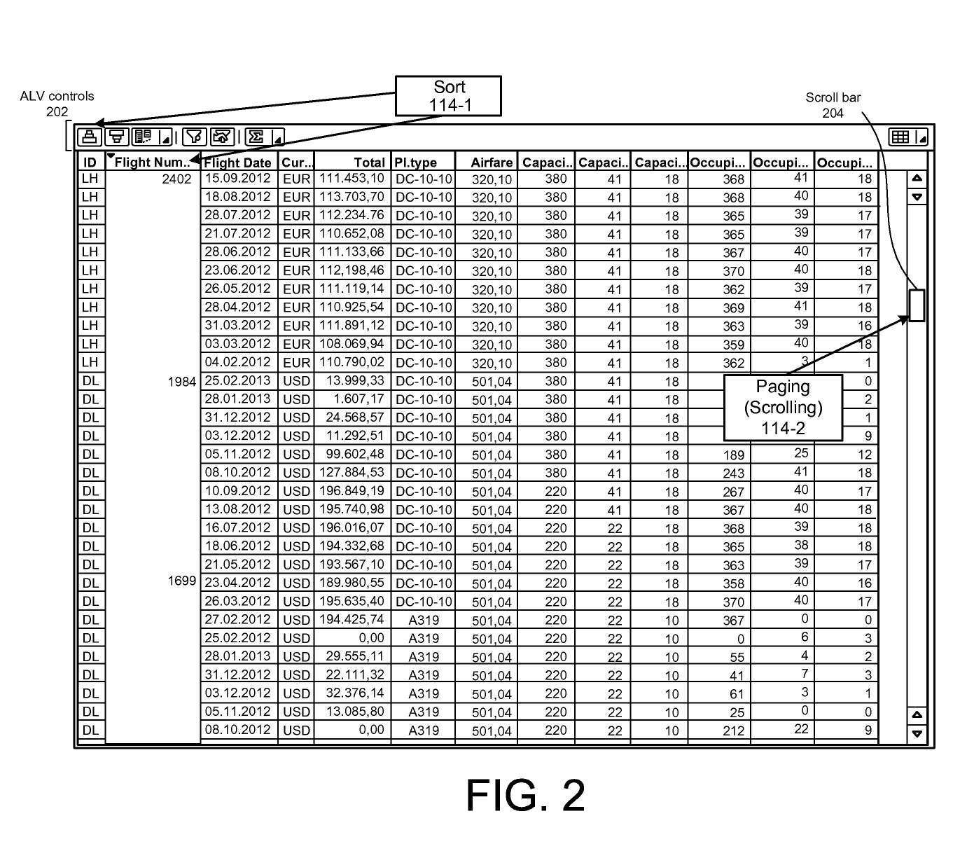

Generally, the generic QE consumer 104 may be considered an API-based application that enables communications between the application 102 and an application server 125 (e.g., ABQI), thereby communicating with the in-memory database 134. In one example, the generic QE consumer 104 may include the ALV API, Value Help (e.g., input help, selection help, or F4 help), Floor Plan Manager (FPM), or SAP NetWeaver Gateway, which are all user interface technologies developed by SAP AG. However, generally, the generic QE consumer 104 may be any type of application executing on the application 102 that is configured to communicate with the in-memory database 134 via the application server 125. In other words, the generic QE consumer 104 may represent a generic interface between the application server 125 and the application 102 to support functions such as searching, paging, scrolling, filtering, and/or aggregating and grouping performed at the application server level. The application 102 may be any type of business application that integrates the generic QE consumer 104. As explained later in the disclosure, FIGS. 2-4 illustrate screenshots of an ALV as the generic QE consumer 104 within the context of an airline application as the application 102.

The in-memory database 134 may be a type of database management system that relies on main memory for computer data storage. In contrast, conventional database systems employ a disk storage mechanism. Also, the in-memory database 134 may support real-time analytics and transactional processing including replication and aggregation techniques. In one embodiment, the in-memory database 134 may be HANA Enterprise 1.0 (any other versions) that is developed by SAP AG.

The query engine 126 may also be referred to a query interface. For example, in one embodiment, the query engine 126 may include an ABQI query interface (e.g., ABQI) or otherwise called an SADL query engine. In this context, the ABQI query interface may be an abstract database interface for the generic QE consumer 104. The query engine 126 may include at least one processor 131 and a storage medium 132 (e.g., a non-transitory computer readable medium). The storage medium 132 may include instructions, that when executed, are configured to cause the at least one processor 131 to perform the functions of the query engine 126, as further explained below. Also, the application server 125 and/or the query engine 126 may include other components that are well known to one of ordinary skill in the art.

According to the embodiments, in order to perform an authority check within the query execution, the query engine 126 may include an authorization handler 127, a query generator 128 that generates the database query statement 129, and a database selector 130 that retrieves data from the in-memory database 134 based on the database query statement 129. For example, the authorization handler 127, the query generator 128, and the database selector 130 may be considered the functional components for carrying out the authority check within the context of the query execution. Although FIG. 1 illustrates the authorization handler 127, the query generator 128, and the database selector 130 as separate functional components, these components may be consolidated into one functional component or divided into any number of separate functional components.

The database 118 may be a central authorization database that manages and/or stores the authorization objects 120 and the user authorization profiles 122. Although one database is illustrated as storing both the authorization objects 120 and the user authorization profiles 122, a separate database may store/manage the authorization objects 120 and the user authorization profiles 122.

The authorization objects 120 may include a grouping of fields and the values in these fields are used in the authorization check, as further explained below. However, in general, the authorization objects 120 may be used to deny the current user of the application 102 from viewing confidential data on-screen or denying access to certain types of transactions. In one example, an authorization object 120 may include a grouping of fields specifying permitted activities (e.g., change in data, read request, etc.) that are performed against specified fields (e.g., specific portion(s) of data, customer number, etc.). In particular, each authorization object 120 may include an activity, a transaction code, a text description, a class, and/or an identifier identifying the authorization object 120. The activity may include a number of activity fields, e.g., 01 for create or generate, 02 for change, 03 for display, and 04 for print, edit messages.

The user authorization profiles 122 stored in the database 118 may correspond to different users of the system 100. For example, an application developer may create a user authorization profile 122 to enable/restrict access to data for a particular user. Multiple user authorization profiles 122 may be associated with a single user, or the user may have one corresponding user authorization profile 122. Generally, each user authorization profile 122 (e.g., with reference to user authorization profile 122-1) may include an activity value 123 and one or more authorization conditions 124. For instance, the activity value 123 may represent the type of activity, e.g., 01 for create or generate, 02 for change, 03 for display, and 04 for print, edit messages. The one or more authorization conditions 124 may define the data which is enabled for the particular activity value 123. For example, if the activity value 123 relates to a read operation, the one or more authorization conditions 124 may specify that this user is authorized to view a specific kind of data (e.g., data A-B or 400-500) within a particular column or row of the in-memory database 134.

Referring to FIG. 1, the user interface 108 may receive a user request 114 from a user of the application 102. In one example, the user interface 108 may display table data providing information arranged in the form of a table, which was previously retrieved from the in-memory database 134. However, the embodiments encompass any type of arrangement for the display of data from the in-memory database 134. Then, the user interface 108 may receive the user request 114, which may relate to a type of action performed on the user interface 108 that adjusts the display data. In one example, the user may sort, page (scroll), and/or aggregate and group the displayed data on the user interface 108, which may trigger a request for a query having query parameters 106 to be supplied to the query engine 126 via the generic QE consumer 104.

FIG. 2 illustrates an example of a screenshot of an ALV-based application depicting a sort 114-1 and a page (scroll) 114-2 according to an embodiment. It is noted that FIG. 2 is merely an example of the ALV as the generic QE consumer 104, where the embodiments encompass any type of generic consumer. Referring to FIG. 2, a user may operate ALV controls 202 to trigger the sort 114-1, or operate a scrollbar 204 to trigger the page 114-2. These user requests 114 may prompt the generation of a query execution in order to select data from the in-memory database 134. Accordingly, referring back to FIG. 1, the generic QE consumer 104 may receive the query parameters 106 related to the query to be executed, which is then passed to the query engine 126 (e.g., in particular, the query generator 128) for integration with the authorization conditions 124. The query parameters 106 may include identification of the data relevant to the query, the type of activity related to the data, and/or display information, e.g., instructions to create a new graphical user interface table, table name, and location of the data, as well as other query parameters that are well known to one of ordinary skill in the art

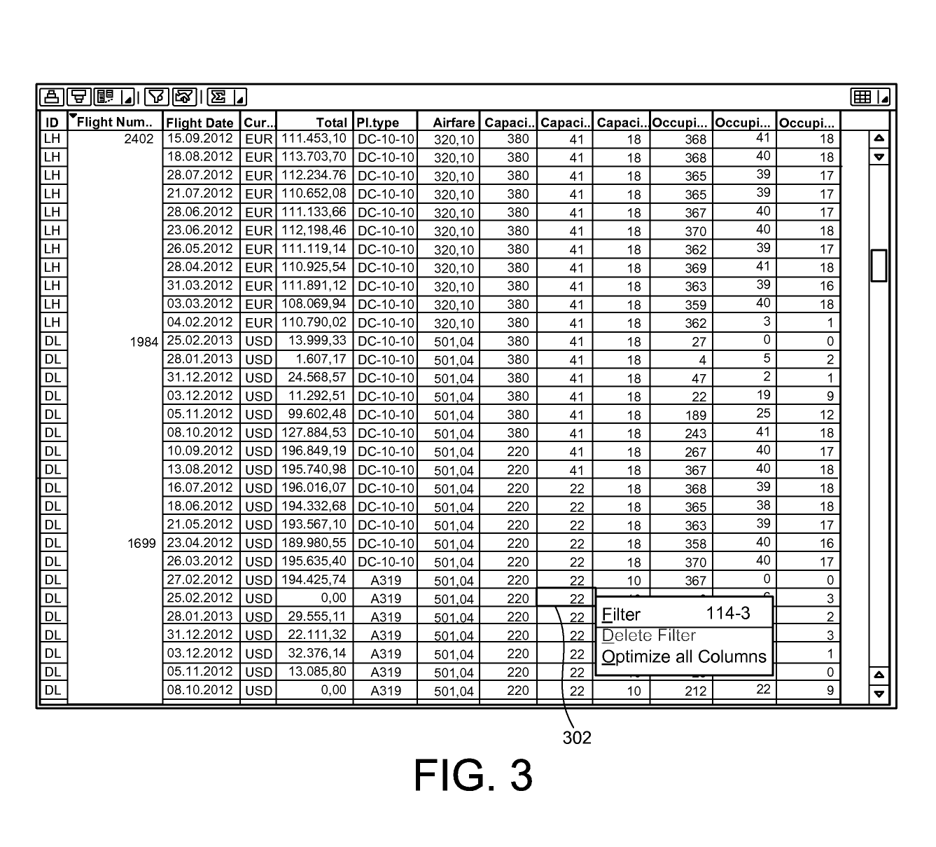

FIG. 3 illustrates an example of a screenshot of an ALV-based application depicting a filter 114-3 according to an embodiment. It is noted that FIG. 3 is merely an example of the ALV as the generic QE consumer 104, where the embodiments encompass any type of generic consumer. Referring to FIG. 3, a user may select (e.g., right-click) a particular cell 302 in order to filter the table data based on the value in the cell 302. This user request 114 may prompt the generation of a query execution to retrieve data from the in-memory database 134. Accordingly, referring back to FIG. 1, the generic QE consumer 104 may receive the query parameters 106 related to the query to be executed, which are then passed to the query engine 126 (i.e., in particular, the query generator 128) for integration with the authority check.

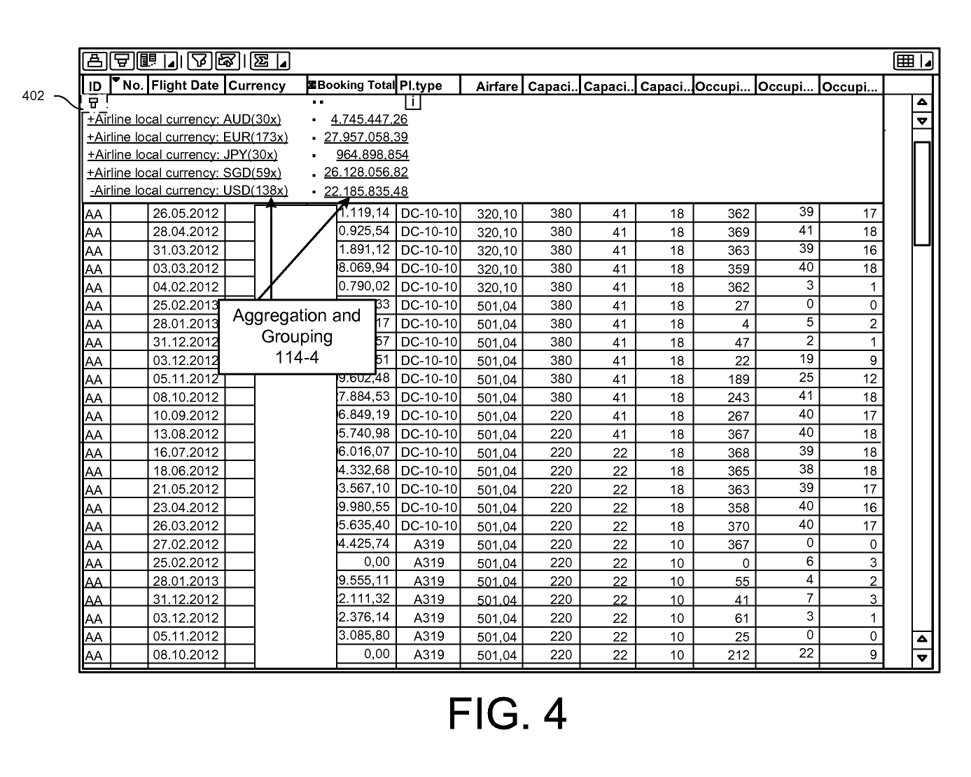

FIG. 4 illustrates an example of a screenshot of an ALV-based application depicting aggregation and grouping 114-4 according to an embodiment. It is noted that FIG. 4 is merely an example of the ALV as the generic QE consumer 104, where the embodiments encompass any type of generic consumer. Referring to FIG. 4, the user may operate an aggregation and grouping control 402 in order to implement the aggregation and grouping 114-4. The aggregation and grouping 114-4 may relate to functions that are well known to one of ordinary skill in the art. This user request 114 may prompt the generation of a query execution in order to retrieve/select data from the in-memory database 134. Accordingly, referring back to FIG. 1, the generic QE consumer 104 may receive the query parameters 106 related to the query to be executed, which is then passed to the query engine 126 (i.e., in particular, the query generator 128) for integration with the authority check. It is noted the data manipulation functions of sorting 114-1, paging 114-2, filtering 114-3, and aggregation and grouping 114-4 are merely examples, where the embodiments encompass any type of action that calls for a query to select data within the in-memory database 134.

Also, the application 102 may receive the authorization objects 120 for the data relevant to the query parameters 106 from the database 118. Then, the application 102 may provide the authorization parameters 110 to the generic QE consumer 104 based on the received authorization objects 120. For example, the authorization parameters 110 may include an identifier 111 that identifies the authorization object 120 relevant to the query parameters 106, a list of activities 112 that identifies the types of activities (e.g., read, change) denied/permitted by the authorization object 120, and mapping information 113 that maps authorization fields to data fields (e.g., column/rows) of the data in the in-memory database 134 and relevant to the query parameters 106. For example, because the data relevant to the query parameters 106 is not yet executed, the mapping information 113 provides a mapping between a database view of the in-memory database 134, and the authorization fields of the authorization objects 120.

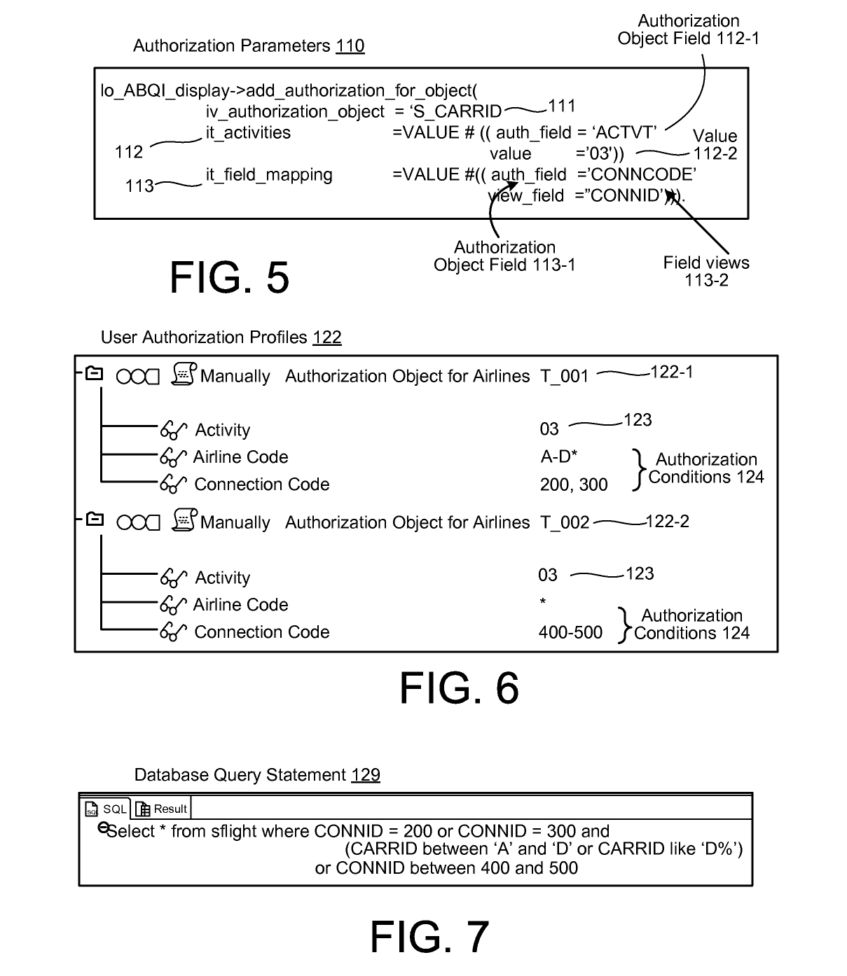

FIG. 5 illustrates a method for obtaining the authorization parameters 110 by the generic QE consumer 104 to be provided to the query engine 126 (e.g., ABQI) according to an embodiment. In this example, for each authorization object 120, the generic QE consumer 104 obtains the authorization parameters 110 such as the identifier 111 identifying the authorization object 120 (e.g., S_CARRID), the list of activities 112 including an authorization object field 112-1, and associated value 112-2, and the mapping information 113 that maps one or more authorization object fields 113-1 to fields of the database table or view containing the data to be retrieved, e.g., data fields 113-2 (e.g., CONNCODE, CONNID). It is noted that there can be more than one activity field (e.g., more than one authorization object field 112-1 and associated value 112-2), e.g., field ACTVT and BUSFCT (Business function).

In this example, the list of activities 112 provides one or more authorization object fields 112-1 that identifies the type(s) of activity (ACTVT) and associated value(s) 112-2 (03). For example, the list of activities 112 may include a list of required authorizations, containing activities relevant for the authorization object 120 (contained therein as authorization object fields) and their required values for the data to be displayed to the user. The mapping information 113 may include pairs of the authorization object fields 113-1, and the data fields 113-2. The authorization object fields 113-1 are the authorization object fields 112-1 except that the authorization object fields 113-1 are mapped to corresponding data fields 113-2 in the mapping information 113. The data fields 113-2 may include the name of the columns or rows (CONNCODE, CONNID) of the database view of the in-memory database 134 for the data relevant to the query parameters 106.

Also, it is noted that the list of activities 112 may be empty. However, if filled, the list of activities 112 may includes pairs of authorization object fields and corresponding values, 112-1 and 112-2. Also, if filled, the mapping information 113 may include pairs of authorization object fields 113-1, and database columns/rows (e.g., data fields 113-2). In a further example, the authorization object SCARRID may include fields ACTVT (activity type field) and CARRID (column name type field). As such, the authorization parameters 110 passed to the application server 125 may be authorization object SCARRID, a list of activities (empty), and a list of mappings (empty), or authorization object SCARRID, a list of activities (ACTVT, 03), and a list of mappings (CARRID, DB_CARR).

Also, the generic QE consumer 104 may check for more than one authorization object 120. In this case, the generic QE consumer 104 may call the method of FIG. 5 multiple times. In this case, the resulting restrictions will be applied sequentially to the data selection (e.g., equivalent to an ‘AND’ between authorization objects).

Referring back to FIG. 1, within the context of the query engine 126, the authorization handler 127 may receive the authorization parameters 110 related to the one or more authorization objects 120 for the data relevant to the query for performing an authority check from the generic QE consumer 104. Also, the authorization handler 127 may obtain at least one user authorization profile 122 for a current user of the application 102 based on the authorization parameters 110. For example, the authorization handler 127 may retrieve the user authorization profiles 122 related to the current user from the database 118. In particular, the authorization handler 127 may retrieve all user authorization profiles 122 related to the current user, and filter these user authorization profiles 122 to obtain the relevant one or more user authorization profiles 122 that are directed to the requested data and match the appropriate activity. Also, it is possible that no user authorization profiles 122 for the authorization object(s) 120 is available, in which case, the received list may be empty, and as a result the processing is stopped, e.g., no data will be returned to the user.

As indicated above, each user authorization profile 122 may include an activity value 123 and one or more authorization conditions 124. The authorization handler 127 may be configured to obtain at least one user authorization profile 122 by filtering the user authorization profiles 122 for user authorization profiles 122 that have the activity value 123 that is the same as the activity value 112-2 (e.g., in FIG. 5) in the list of activities 112 from the authorization parameters 110. For example, the activity field 123 and the authorization conditions 124 may include one or more fields from the authorization object 120. Prior to using the authorization conditions 124 for data selection, the authorization handler 127 may filter the user authorization profiles 122 according to the activity value(s) 123. The user authorization profiles 122 having activity value(s) 123 that do not match the activity value 112-2 in the list of activities 112 are not considered for data selection (e.g., no authorization for this data), as further explained below with reference to FIG. 6.

FIG. 6 illustrates an example of a first user authorization profile 122-1 and a second user authorization profile 122-2 related to the current user according to an embodiment. In this example, the authorization handler 127 has obtained two user authorization profiles (122-1, 122-2) related to the current user. In each of the user authorization profiles 122, the user authorization profile 122 includes the activity value 123, and the one or more authorization conditions 124. The one or more authorization conditions 124 specify which data the current user is authorized to access. For example, the one or more authorization conditions 124 may provide a range of values within a column or row (e.g., CONNCODE relating to the airline code, CONNID relating to the connection code). Also, the one or more authorization conditions 124 may specify a wildcard symbol (*) that indicates no restrictions are associated with the column/row for the data relevant to the query.

For example, with respect to the first user authorization profile 122-1, for the activity value 123—03, the user is authorized to access data A-D of the airline code, and 200 or 300 of the connection code. With respect to the second user authorization profile 122-2, for the activity value 123—03, the user is authorized to access all the data relating to the airline code (e.g., * indicates a wildcard symbol that means all data is accessible), and 400 through 500 of the connection code. As indicated above, the authorization handler 127 has obtained these user authorization profiles 122 because the activity value 123 matches the activity value 112-2 of the authorization parameters 110. In other words, if the activity value relates to a read operation (03), the user is authorized to view data A-D, and 200 or 300 with respect to the first user authorization profile 122-1, and authorized to view all data for the airline code, and within the range 400-500 for the connection code with respect to the second user authorization profile 122-2.

The query generator 128 may be configured to receive the query parameters 106 from the generic QE consumer 104, and integrate the query parameters 106 with the one or more authorization conditions 124 to obtain the database query statement 129. For example, the one or more authorization conditions 124 may be transformed from the internal authorization format of the user authorization profile 122 into a condition to be processed by the query engine 126. For example, referring back to FIG. 6, the one or more authorization conditions 124 provide the user with authorization to access 1) A-D from the first user authorization profile 122-1 for Airline Code, and 200 or 300 for Connection Code, and 2) all data (e.g., * indicates a wildcard providing no restrictions) from the second user authorization profile 122-2 for Airline Code, and 400-500 for Connection code. First, the query generator 128 may transform the format of these authorization conditions 124 to one or more conditions that are compatible with a query execution involving the in-memory database 134 according to a set of conversion rules. Essentially, the conversion rules introduce Boolean operators (e.g., =, <, >, etc.) that represent the authorization conditions 124.

In more detail, the query generator 128 may transform the ranges and wildcard symbols of the authorization conditions 124 into conditions based on ‘=’, ‘<’, ‘>’, ‘between’ and ‘cp’ operators, according to the set of conversion rules in the table below.

TABLE 1

| | | High Range Values | | | |
|---|---|---|---|---|---|
| | | — | B | B* or B*Y | * or *Y |
| Low | — | | <col> <= | <col> <= | <col> cp |
| Range | | | ‘B’ | ‘B’ or | ‘*’ |
| Values | | | | <col> cp | |
| | | | | ‘B*’ | |
| | A | <col> = | <col> bt | <col> bt | <col> >= |
| | | ‘A’ | ‘A’ and | ‘A’ and | ‘A’ |
| | | | ‘B’ | ‘B’ or | |
| | | | | <col> cp | |
| | | | | ‘B*’ | |
| | A* or A*X | <col> cp | <col> bt | <col> bt | <col> >= |
| | | ‘A*’ | ‘A’ and | ‘A’ and | ‘A’ |
| | | | ‘B’ | ‘B’ or | |
| | | | | <col> cp | |
| | | | | ‘B*’ | |
| | * or *X | <col> cp | <col> <= | <col> <= | <col> cp |
| | | ‘*’ | ‘B’ | ‘B’ or | ‘*’ |
| | | | | <col> cp | |
| | | | | ‘B*’ | |

In Table 1, <col> stands for the column name in the database query statement 129, ‘A’ is the lower value, and ‘B’ is the higher value in the range as maintained in the user authorization profile 122. Characters following the wildcard ‘*’ may be disregarded, and ‘A*X’ may be considered equivalent to ‘A*’.

A special transformation is done for the case that the high boundary of the maintained authorizations is in the form ‘B*’. In this case, values lower than B or covering the pattern ‘B*’ are sought as provided in Eq. (1):

A≦x≦B* [symbol] A≦x≦BVxcpB* Eq. (1)

In addition, referring back to FIG. 5, the query generator 128 incorporates the mapping information 113 into the database query statement 129. For instance, the Airline Code and the Connection Code within the user authorization profile 122 may not correspond to how the data is stored in the in-memory database 134. As such, the query generator 128 uses the mapping information 113 to provide the search terms for the data fields in the in-memory database 134, as further explained with reference to FIG. 7.

FIG. 7 illustrates the database query statement 129 according to an embodiment. In this example, the database query statement 129 may include a Script Query Language (SQL) statement providing a WHERE clause that defines the attributes of the query execution. The database query statement 129 may include the WHERE clause for the query execution, which links the data fields 113-2 of the mapping information 113 with the transformed authorization conditions 124. In this example, the database query statement 129 indicates to select the data field 113-2 (CONNID) with the value 200 or 300, and the data field 113-2 (CARRID) between A and D or all data involving the CARRID, or the data field 113-2 (CONNID) between 400 and 500.

It is noted that the database query statement 129 are lengthened by adding the authorization conditions 124, where the database settings may have to adjusted in case the length exceeds the allowable size.

Referring back to FIG. 1, the database selector 130 may be configured to obtain the authorized data 116 from the in-memory database 134 based on the database query statement 129. The authorized data 116 may be considered a subset of the data relevant to the query that is authorized for display. For example, the database selector 130 may restrict the data selection of the query to the authorized data 116 as defined in the database query statement 129. Then, the query engine 126 provides the authorized data 116 to the application 102 via the generic QE consumer 104 for display on the user interface 108.

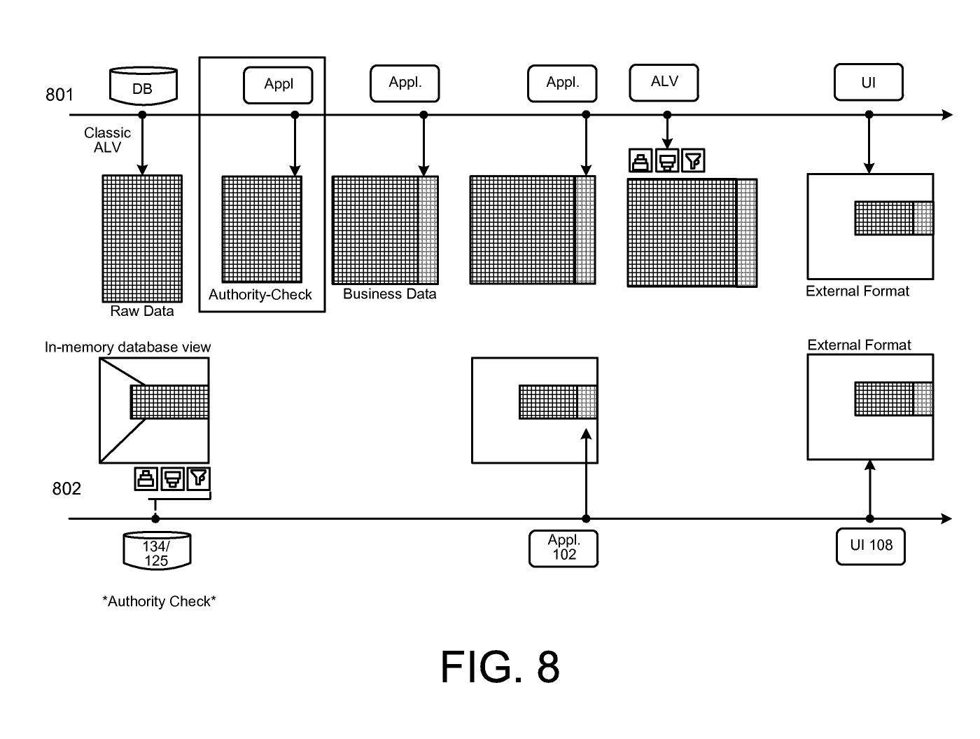

FIG. 8 illustrates a data flow (801, 802) for the authority check within the system 100 of FIG. 1 and a conventional system according to an embodiment. For example, the data flows 801 and 802 both relate to the ALV-based application, however, dataflow 801 corresponds to a conventional ALV embodiment while the dataflow 802 corresponds to the—ALV based application within the context of the system 100 of FIG. 1. With respect to the dataflow 801, as shown in FIG. 8, the application loads the raw data from a database, and then performs an authority check on the raw data on a row-by-row basis, as described above. In this particular example, the application determines that at least a portion of the raw data is not authorized for display (e.g., the right portion of the table layout). Subsequently, the authorized data is presented to the ALV, and then in an external format by the user interface.

In contrast, with respect to the dataflow 802, the ALV is integrated with the database view of the in-memory database 134 via the application server 125. As a result, the application 102 obtains only the authorized data, which is then presented to the user interface 108 for display. As such, the application 102 does not load the raw data for the table display to perform an authority check. Rather, the authority check is pushed down to the query engine 126, which enhances the database query statement 129 with the authorization conditions 124 such that only authorized data is retrieved from the in-memory database 134.

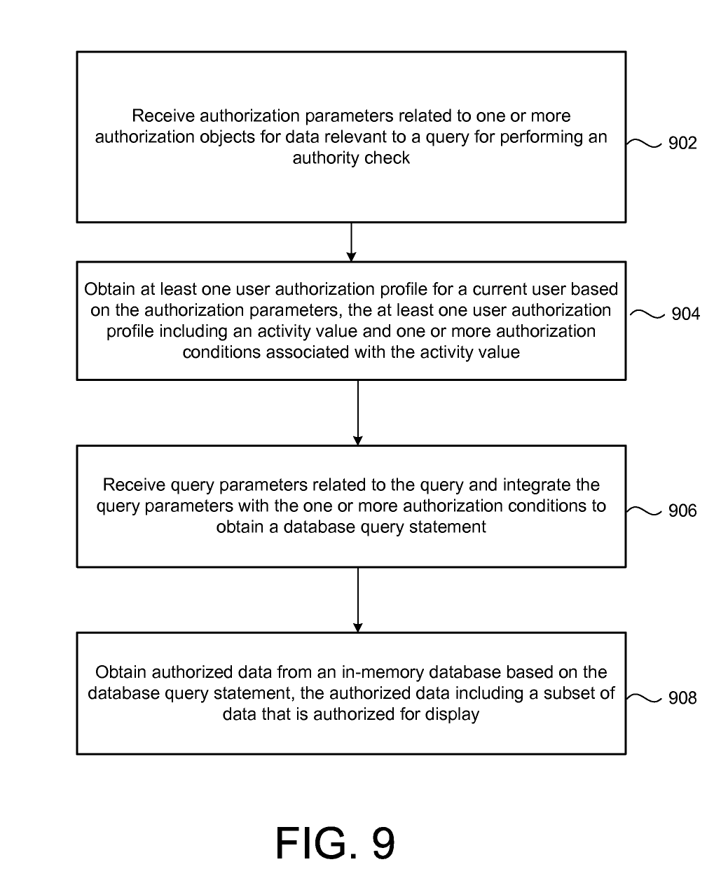

FIG. 9 is a flowchart illustrating example operations of the performance of the authority check within the query engine according to an embodiment. Although FIG. 9 is illustrated as a sequential, ordered listing of operations, it will be appreciated that some or all of the operations may occur in a different order, or in parallel, or iteratively, or may overlap in time.

Authorization parameters related to one or more authorization objects for data relevant to a query for performing an authority check may be received (902). For example, referring to FIG. 1, the authorization handler 127 may receive the authorization parameters 110 for data relevant to a query for performing an authority check. In more detail, the application 102 may receive the authorization objects 120 for the data relevant to the query parameters 106 from the database 118. Then, the application 102 may provide the authorization parameters 110 to the generic QE consumer 104 based on the received authorization objects 120.

The authorization parameters 110 may include an identifier 111 that identifies the authorization object 120 relevant to the query parameters 106, a list of activities 112 that identifies the types of activities (e.g., read, change) denied/permitted by the authorization object 120, and mapping information 113 that maps authorization fields 113-1 to data fields 113-2 (e.g., column/rows) of the data in the in-memory database 134 and relevant to the query parameters 106. The list of activities 112 may include the list of required authorizations, containing activities relevant for the one or more authorization objects 120 (contained therein as authorization object fields) and their required values for the data to be displayed to the user. Because the data relevant to the query parameters 106 is not yet executed, the mapping information 113 provides a mapping between a database view of the in-memory database 134 and the authorization fields of the authorization objects 120.

Within the context of the query engine 126, the authorization handler 127 may receives the authorization parameters 110 related to the one or more authorization objects 120 for the data relevant to the query for performing an authority check from the generic QE consumer 104.

At least one user authorization profile for a current user may be obtained based on the authorization parameters, where the at least one user authorization profile includes an activity value and one or more authorization conditions associated with the activity value (904). The activity value may relate to a particular action such as read data from a database. However, the activity value may correspond to any type of action. For example, referring to FIG. 1, the authorization handler 127 may obtain at least one user authorization profile 122 for a current user of the application 102 based on the authorization parameters 110. However, it is noted that the authorization handler 127 may not obtain any user authorization profiles 122, e.g., if none of the activity values 123 match the activity values 112-2 of the list of activities 112, which would indicate that no data is authorized for display. For example, the authorization handler 127 may retrieve the user authorization profiles 122 related to the current user from the database 118. In particular, the authorization handler 127 may retrieve all user authorization profiles 122 related to the current user, and filter these user authorization profiles 122 to obtain the relevant one or more user authorization profiles 122 that are directed to the requested data and match the appropriate activity. For example, each user authorization profile 122 may include the activity value 123 and one or more authorization conditions 124. The authorization handler 127 may be configured to obtain at least one user authorization profile 122 by filtering the user authorization profiles 122 for user authorization profiles 122 that have the activity value 123 that is the same as the activity value 112-2 (e.g., in FIG. 5) in the list of activities 112 from the authorization parameters 110.

Query parameters related to the query may be received, and the query parameters may be integrated with the one or more authorization conditions to obtain a database query statement (906). For example, referring to FIG. 1, the query generator 128 may be configured to receive the query parameters 106 from the generic QE consumer 104, and integrate the query parameters 106 with the one or more authorization conditions 124 to obtain the database query statement 129. For example, the one or more authorization conditions 124 may be transformed from the internal authorization format of the user authorization profile 122 into a condition to be processed by the query engine 126. The query generator 128 may transform the format of these authorization conditions 124 to one or more conditions that are compatible with a query execution involving the in-memory database 134 according to a set of conversion rules. Essentially, the conversion rules introduce Boolean operators (e.g., =, <, >, etc.) that represent the authorization conditions 124. In more detail, the query generator 128 may transform the ranges and wildcard symbols of the authorization conditions 124 into conditions based on ‘=’, ‘<’, ‘>’, ‘between’ and ‘cp’ operators, according to the set of conversion rules in Table 1 provided above.

Authorized data may be obtained from an in-memory database based on the database query statement, where the authorized data includes a subset of data that is authorized for display (908). For example, referring to FIG. 1, the database selector 130 may be configured to obtain the authorized data 116 from the in-memory database 134. The authorized data 116 may be considered a subset of the data relevant to the query that is authorized for display. For example, the database selector 130 may restrict the data selection of the query to the authorized data 116 as defined in the database query statement 129. In other words, the subset of data may represent data that is a smaller set than the data that would be retrieved by the database selector 120 if the database query statement 129 was not integrated with the authorization conditions 124. Then, the query engine 126 provides the authorized data 116 to the application 102 via the generic QE consumer 104 for display on the user interface 108.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A query engine for integrating authorization conditions within a database query statement, the query engine comprising:
at least one processor;
a non-transitory computer-readable storage medium including instructions executable by the at least one processor, the instructions configured to implement,
an authorization handler configured to receive authorization parameters related to one or more authorization objects for data relevant to a query for performing an authority check;
the authorization handler configured to obtain at least one user authorization profile for a current user based on the authorization parameters, the at least one user authorization profile including an activity value and one or more authorization conditions associated with the activity value;
a query generator configured to receive query parameters related to the query and integrate the query parameters with the one or more authorization conditions to obtain a database query statement; and
a database selector configured to obtain authorized data from an in-memory database based on the database query statement, the authorized data including a subset of data that is authorized for display.

2. The query engine of claim 1, wherein the authorization handler configured to receive authorization parameters related to one or more authorization objects for data relevant to a query for performing an authority check includes receiving the authorization parameters from an application via an application programming interface (API).

3. The query engine of claim 1, wherein the authorization parameters includes an identifier identifying an authorization object, a list of one or more activities each having at least one authorization object field and associated value, and mapping information mapping the at least one authorization object field to one or more data fields of the in-memory database.

4. The query engine of claim 3, wherein the authorization handler configured to obtain at least one user authorization profile for a current user based on the authorization parameters includes obtaining the at least one user authorization profile having the activity value that matches the associated value of the authorization object field.

5. The query engine of claim 3, wherein the query generator configured to receive query parameters related to the query and integrate the query parameters with the one or more authorization conditions to obtain a database query statement includes integrating the query parameters with the one or more data fields such that the database query statement corresponds to a format of the in-memory database.

6. The query engine of claim 5, wherein the one or more data fields relate to a column or row in the in-memory database, and the one or more authorization conditions relate a range within the column or row.

7. The query engine of claim 1, wherein the query generator configured to receive query parameters related to the query and integrate the query parameters with the one or more authorization conditions to obtain a database query statement includes transforming a format of the one or more authorization conditions into one or more conditions according to a set of conversion rules.

8. The query engine of claim 1, wherein the one or more authorization conditions includes a range of values associated with the activity value, and the query generator is configured to specify the range of values in the database query statement, and the database selector is configured to obtain data corresponding to the range of values from the in-memory database as the authorized data.

9. The query engine of claim 1, wherein the query parameters relates to at least one of paging, sorting, filtering, and aggregation and grouping.

10. A computer program product tangibly embodied on a non-transitory computer-readable storage medium and including executable code that, when executed, is configured to cause a query engine to integrate authorization conditions within a database query statement, the executable code comprising instructions to:
receive authorization parameters related to one or more authorization objects for data relevant to a query for performing an authority check;
obtain at least one user authorization profile for a current user based on the authorization parameters, the at least one user authorization profile including an activity value and one or more authorization conditions associated with the activity value;
receive query parameters related to the query and integrate the query parameters with the one or more authorization conditions to obtain a database query statement; and
obtain authorized data from an in-memory database based on the database query statement, the authorized data including a subset of data that is authorized for display.

11. The computer program product of claim 10, wherein the instructions to receive authorization parameters related to one or more authorization objects for data relevant to a query for performing an authority check includes receiving the authorization parameters from an application via an application programming interface (API).

12. The computer program product of claim 10, wherein the authorization parameters includes an identifier identifying an authorization object, a list of one or more activities each having at least one authorization object field and associated value, and mapping information mapping the at least one authorization object field to one or more data fields of the in-memory database.

13. The computer program product of claim 12, wherein the instructions to obtain at least one user authorization profile for a current user based on the authorization parameters includes obtaining the at least one user authorization profile having the activity value that matches the associated value of the authorization object field.

14. The computer program product of claim 10, wherein the instructions to receive query parameters related to the query and integrate the query parameters with the one or more authorization conditions to obtain a database query statement includes integrating the query parameters with the one or more data fields such that the database query statement corresponds to a format of the in-memory database.

15. The computer program product of claim 14, wherein the one or more data fields relate to a column or row in the in-memory database, and the one or more authorization conditions relate a range within the column or row.

16. The computer program product of claim 10, wherein the instructions to receive query parameters related to the query and integrate the query parameters with the one or more authorization conditions to obtain a database query statement includes transforming a format of the one or more authorization conditions into one or more conditions according to a set of conversion rules.

17. The computer program product of claim 10, wherein the one or more authorization conditions includes a range of values associated with the activity value, and the instructions include specifying the range of values in the database query statement, and obtaining data corresponding to the range of values from the in-memory database as the authorized data.

18. A method for integrating authorization conditions within a database query statement, the method comprising:
receiving, by at least one processor, authorization parameters related to one or more authorization objects for data relevant to a query for performing an authority check;
obtaining, by at least one processor, at least one user authorization profile for a current user based on the authorization parameters, the at least one user authorization profile including an activity value and one or more authorization conditions associated with the activity value;
receiving, by at least one processor, query parameters related to the query and integrating, by at least one processor, the query parameters with the one or more authorization conditions to obtain a database query statement; and
obtaining, by at least one processor, authorized data from an in-memory database based on the database query statement, the authorized data including a subset of data that is authorized for display.

19. The method of claim 18, wherein the authorization parameters includes an identifier identifying an authorization object, a list of one or more activities each having at least one authorization object field and associated value, and mapping information mapping the at least one authorization object field to one or more data fields of the in-memory database.

20. The method of claim 19, wherein the obtaining at least one user authorization profile for a current user based on the authorization parameters includes obtaining the at least one user authorization profile having the activity value that matches the associated value of the authorization object field.
